(19) United States
(12) Patent Application Publication
(10) Pub. No.: US 2025/0056460 A1
(43) Pub. Date: Feb. 13, 2025

(54) COMMUNICATION TECHNIQUES

(71) Applicant: FRAUNHOFER-GESELLSCHAFT ZUR FOERDERUNG DER ANGEWANDTEN FORSCHUNG E.V., Muenchen (DE)

(72) Inventors: Kai Lennert BOBER, Berlin (DE); Volker Jungnickel, Berlin (DE); Eric Ackermann, Berlin (DE); Dominic Schulz, Berlin (DE)

(21) Appl. No.: 18/928,857

(22) Filed: Oct. 28, 2024

Related U.S. Application Data
(63) Continuation of application No. PCT/EP2023/061411, filed on Apr. 28, 2023.

(30) Foreign Application Priority Data
Apr. 29, 2022 (EP) 22171041.1

(51) Int. Cl. H04W 56/00; H04W 72/0446

(52) U.S. Cl. CPC H04W 56/0045; H04W 72/0446

(57) ABSTRACT

A communication apparatus wherein the communication apparatus is configured to transmit and/or receive a plurality of packets using a scheduling related to a reference time; wherein the communication apparatus is configured to transmit a synchronization information; wherein the communication apparatus is configured to include into the synchronization information a timing information defining a timing of the transmission of the synchronization information with respect to the reference time. A communication apparatus wherein the communication apparatus is configured to receive a synchronization information; wherein the communication apparatus is configured to transmit and/or receive a plurality of packets using a scheduling related to a reference time; wherein the communication apparatus is configured to evaluate a timing information, which is included in a synchronization information and which defines a timing of the transmission of the synchronization information with respect to the reference time, in order to perform a synchronization.

### CROSS-REFERENCES TO RELATED APPLICATIONS

This application is a continuation of copending International Application No. PCT/EP2023/061411, filed Apr. 28, 2023, which is incorporated herein by reference in its entirety, and additionally claims priority from European Application No. EP 22 171 041.1, filed Apr. 29, 2022, which is incorporated herein by reference in its entirety.

### TECHNICAL FIELD

Hereinbelow, techniques are disclosed for the communication between at least one first apparatus communication and at least one second communication apparatus. For example, a second apparatus may be an arrangement (e.g., with wireless frontends, e.g. optical frontends, e.g. VLC communications), and the at least one first apparatus may be one or more devices (e.g., wireless devices, e.g. optical devices). In some examples, the arrangement (or the second apparatus) is fixed (at least in one frontend(s)) and the and one or more first devices may be mobile. Techniques for synchronization are in particular discussed. Variable MAC Scheduling for Real-time Light Communication are also disclosed.

### BACKGROUND OF THE INVENTION

Wireless communications (e.g., visible light communications, VLCs and other communications, e.g. radio frequency, RF, communications, ultrasound communications, etc.) are known, e.g., between an arrangement (e.g. with fixed relays or frontends) and one or multiple devices (e.g., mobile devices).

In several cases, elaborated medium access strategies are necessary: granted time slots may be assigned to each communication apparatus, thereby avoiding collisions of transmissions. In some cases, contention-based time slots may be provided, e.g. for new communication apparatus to join a communication network. This has requested complicated synchronization techniques between the devices. In some cases, it has been decided to make use of a beacon signal, which is periodically transmitted by a master communication apparatus (which may be also the scheduler) to the other communication apparatuses. The beacon signal has also been held important for transmitting control signalization from the master communication apparatus to the other communication apparatuses.

However, some problems have notwithstanding been experienced. Indeed, there is a latency from the transmission of the beacon signal and also for each communication apparatus to process the synchronization. This means that, before the beacon signal is received and the synchronization is processed, it is not possible for the communication apparatuses to perform communications, and they need to waist some time waiting.

Moreover, different traffic conditions (and different nature of commutations, such as different rankings of urgency) have caused congestion in some cases: some important packets have experienced high delay, leading to non-acceptable delays.

### SUMMARY

An embodiment may have a communication apparatus, wherein the communication apparatus is configured to transmit and/or receive a plurality of packets using a scheduling related to a reference time; wherein the communication apparatus is configured to transmit a synchronization information; wherein the communication apparatus is configured to include into the synchronization information a timing information defining a timing of the transmission of the synchronization information with respect to the reference time.

Another embodiment may have a communication method, comprising: transmitting and/or receiving a plurality of packets using a scheduling related to a reference time; the method further comprising transmitting a synchronization information; wherein transmitting a synchronization information comprises including into the synchronization information a timing information defining a timing of the transmission of the synchronization information with respect to the reference time.

Another embodiment may have a non-transitory storage unit storing instructions which, when executed by a processor, cause the processor to: control the transmission and/or reception of a plurality of packets using a scheduling related to a reference time; control the transmission of a synchronization information; wherein the synchronization information comprises including into the synchronization information a timing information defining a timing of the transmission of the synchronization information with respect to the reference time.

Another embodiment may have a communication apparatus, wherein the communication apparatus is configured to receive a synchronization information; wherein the communication apparatus is configured to transmit and/or receive a plurality of packets using a scheduling related to a reference time; wherein the communication apparatus is configured to evaluate a timing information, which is included in a synchronization information and which defines a timing of the transmission of the synchronization information with respect to the reference time, in order to perform a synchronization.

Another embodiment may have a communication method comprising receiving a synchronization information; transmitting and/or receiving a plurality of packets using a scheduling related to a reference time; evaluating a timing information, which is included in a synchronization information and which defines a timing of the transmission of the synchronization information with respect to the reference time, in order to perform a synchronization.

Another embodiment may have a non-transitory storage unit storing instructions which, when executed by a processor, cause the processor to control the reception of a synchronization information; control the transmission and/or reception of a plurality of packets using a scheduling related to a reference time; evaluate a timing information, which is included in a synchronization information and which defines a timing of the transmission of the synchronization information with respect to the reference time, in order to perform a synchronization.

The invention is defined in the independent claims.

Through the present independent claims it is possible to solve, or at least alleviate, the issues above. In particular, it is possible to schedule the synchronization information (including timing information) in the most appropriated time position. The synchronization information (or even any control signalization) may be delayed, anticipated, or even skipped in some cases. Hence, if many application data (e.g. uplink or downlink application data, e.g. for urgent communications) are to be transmitted, then the synchronization information may be delayed (or even skipped in some cases).

The invention also permits a less rigid approach to the synchronization, since it is possible to synchronize the devices to a time instant (e.g. timing reference or reference time) which is not necessarily the time in which the beacon signal is transmitted, and therefore the synchronization information may be transmitted at any time.

Notably, the synchronization is performed even if the synchronization information is be delayed or anticipated.

According to an aspect there is provided a communication apparatus (e.g. a second communication apparatus, e.g. including a coordinator)
wherein the communication apparatus is configured to transmit and/or receive a plurality of packets using a scheduling related to a reference time;
wherein the communication apparatus is configured to transmit a synchronization information;
wherein the communication apparatus is configured to include into the synchronization information a timing information defining a timing of the transmission of the synchronization information with respect to the reference time.

The communication apparatus may be configured to include, in the timing information, a time distance from the transmission of the synchronization information and the reference time.

The communication apparatus may be configured to include, in the timing information, information on the time distance from the reference time to the next timing reference (e.g. reference time).

The communication apparatus may be configured to provide scheduling information to the different communication apparatuses assigning exclusive time slots to each of the different communication apparatuses.

The communication apparatus may be configured to provide, to the different communication apparatuses, scheduling information assigning exclusive time slots to the communication apparatus for the transmission of at least some control signalization.

The communication apparatus may be configured to further transmit at least some control signalization event-driven.

The communication apparatus may be such that the control signalization includes at least the synchronization information.

The communication apparatus may be configured to delay or to anticipate the transmission of a control signalization in case a higher-layer application requires the transmission and/or reception of a transmission.

The communication apparatus may be configured, in case of the higher-layer application requiring the transmission and/or reception of a transmission of a payload data, to check whether, according to the scheduling, at least some slots are free, and to therefore delay or anticipate the transmission of the control signalization in the free slots in a same superframe, otherwise waiting for the next superframe.

The communication apparatus may be such that the control signalization includes scheduling information for the subsequent transmissions.

The communication apparatus may be such that the control signalization includes the synchronization information for the subsequent transmissions.

The communication apparatus may be such that the control signalization includes announcement information.

The communication apparatus may be such that the control signalization includes random access timing information providing information on slots which are grant-free.

The communication apparatus may be such that the control signalization includes granted access timing information providing information on time slots which are grant-free.

The communication apparatus may be configured to define the scheduling information by keeping into account traffic.

The communication apparatus may be configured to define the scheduling information by:
in case of comparatively higher traffic congestion, reducing the amount of time slots for the transmission of control signalization and/or increasing the amount of granted time slots assigned to at least one of the different communication apparatuses; and/or
in case of comparatively lower traffic congestion, increasing the amount of time slots for the transmission of control signalization and/or reducing the amount of granted time slots assigned to at least one of the different communication apparatuses.

The communication apparatus may be such that the urgency of the transmissions and/or receptions is ranked according to an urgency ranking, wherein the communication apparatus is configured to
in case of comparatively higher ranking transmissions and/or receptions, reducing the amount of time slots for the transmission of control signalization and/or increasing the amount of granted time slots assigned to at least one of the different communication apparatuses; and/or
in case of comparatively lower ranking transmissions and/or receptions, increasing the amount of time slots for the transmission of control signalization and/or reducing the amount of granted time slots assigned to at least one of the different communication apparatuses.

The communication apparatus may be configured to define the scheduling by reinstating the time slots for the transmission of the control signalization in case of a threshold condition is reached.

The communication apparatus may further comprise a plurality of frontends configured to simultaneously transmit and/or receive different packets through the different frontends.

The communication apparatus may be configured to selectively simultaneously transmit synchronization information in different time slots for different frontends.

The communication apparatus may include or being connected to, a higher-layer application, the communication apparatus using information on characteristics of real-time application data streams from the higher-layer application.

The communication apparatus may be such that the information on characteristics of real-time application data streams contain one or more of the following: the periodicity of application data streams, the maximum allowed delay, the maximum allowed delay variation, the maximum allowed loss ratio of datagrams.

The communication apparatus may be such that the communication apparatus is configured to use the information on the characteristics of real-time application data streams, e.g. in such a way that, if the information on the characteristics of real-time application data streams requires a particular maximum latency for the transmission and/or reception of a particular transmission, time slots, which are not scheduled for a particular different communication apparatus, are awarded to the different communication apparatus, and/or other transmissions from the communication apparatus are shifted towards subsequent time slots.

The communication apparatus may be configured to transmit and/or receive the plurality of packets as wireless signals and to transmit the synchronization information in a wireless signal.

The communication apparatus may be configured to transmit and/or receive the plurality of packets as optical signals and to transmit the synchronization information in optical signal.

According to an aspect, there is provided a communication method, comprising:
transmitting and/or receiving a plurality of packets using a scheduling [related to a reference time;
the method further comprising transmitting a synchronization information;
wherein transmitting a synchronization information comprises including into the synchronization information a timing information defining a timing of the transmission of the synchronization information with respect to the reference time.

According to an aspect there is provided a non-transitory storage unit storing instructions which, when executed by a processor, cause the processor to:
control the transmission and/or reception of a plurality of packets using a scheduling related to a reference time;
control the transmission of a synchronization information;
wherein the synchronization information comprises including into the synchronization information a timing information defining a timing of the transmission of the synchronization information with respect to the reference time.

According to an aspect there is provided a communication apparatus (e.g. a first communication apparatus, e.g. a user equipment),
wherein the communication apparatus is configured to receive a synchronization information;
wherein the communication apparatus is configured to transmit and/or receive a plurality of packets using a scheduling related to a reference time;
wherein the communication apparatus is configured to evaluate a timing information, which is included in a synchronization information and which defines a timing of the transmission of the synchronization information with respect to the reference time, in order to perform a synchronization.

The communication apparatus may be configured to evaluate, from the timing information, information on the time distance from the timing reference to the next timing reference (e.g. from the reference time to the next reference time).

The communication apparatus may be configured to resynchronize by comparing the time position of the reference time as measured with the timing information.

The communication apparatus may be configured to read the timing information so as to acknowledge a time drift with respect to the timing information, and to thereby modify the time knowledge with the time drift.

The communication apparatus may be configured to count a number of slots between the current reference time and the start the synchronization information, and compare the counted number of slots with a number encoded in the timing information, to thereby calculate an offset and compensate for the offset by adjusting its timing to the timing information.

The communication apparatus may be configured to receive scheduling information assigning exclusive time slots to the communication apparatus and different exclusive time slots to different communication apparatuses, so that the communication apparatus transmits in the time slots assigned to it and refrains from transmitting in the time slots assigned to the different communication apparatuses.

The communication apparatus may be configured to receive scheduling information assigning exclusive time slots to a master communication apparatus for the transmission of control signalization, so that the communication apparatus receives the control signalization in the time slots assigned to the transmission of the at least control signalization.

The communication apparatus may be configured to receive at least some control signalization event-driven during the non-assigned time slots, and the master communication apparatus may therefore occupy the non-assigned slots to transmit at least some control signalization event-driven, without necessarily scheduling those event-driven control signalization(s)).

The communication apparatus may be such that the control signalization includes scheduling information for the subsequent transmissions.

The communication apparatus may be such that the control signalization includes the synchronization information for the subsequent transmissions.

The communication apparatus may be such that the control signalization includes announcement information.

The communication apparatus may be such that the control signalization includes random access timing information, providing information on slots which are grant-free.

The communication apparatus may be such that the control signalization includes granted access timing information, providing information on time slots which are grant-free.

The communication apparatus may be configured to include, or be connected to, a high-layer application, wherein the communication apparatus is configured to receive payload data from the higher-layer application and transmit the payload data according to the scheduling, and/or wherein the communication apparatus is configured to transmit payload data to the higher-layer application received according to the scheduling.

The communication apparatus may be such that if information on characteristics of real-time application data streams as defined by a higher-layers application requires a particular maximum latency for the transmission and/or reception of a particular transmission, time slots, which are not scheduled for the communication apparatus, are awarded to the different communication apparatus.

The communication apparatus may be configured to evaluate, from the timing information, a time distance between the timing information as encoded and the timing reference (e.g. reference time) as measured.

The communication apparatus may be configured, in case of drift between the timing information as encoded and the timing reference (e.g. reference time) as measured, to adjust the internal clock to the timing information as encoded.

The communication apparatus may be configured to transmit and/or receive the plurality of packets as wireless signals and to receive the synchronization information in wireless signals.

The communication apparatus may be configured to transmit and/or receive the plurality of packets as optical signals and to receive the synchronization information in optical signals.

According to an aspect there is provided a communication method comprising
receiving a synchronization information;
transmitting and/or receiving a plurality of packets using a scheduling [related to a reference;
evaluating a timing information, which is included in a synchronization information and which defines a timing of the transmission of the synchronization information with respect to the reference time [, in order to perform a synchronization.
According to an aspect there is provided a non-transitory storage unit storing instructions which, when executed by a processor, cause the processor to
control the reception of a synchronization information;
control the transmission and/or reception of a plurality of packets using a scheduling related to a reference time;
evaluate a timing information, which is included in a synchronization information and which defines a timing of the transmission of the synchronization information with respect to the reference time, in order to perform a synchronization.

### BRIEF DESCRIPTION OF THE DRAWINGS

Embodiments of the present invention will be detailed subsequently referring to the appended drawings, in which:

FIG. 1 shows an example of wireless communication.

FIG. 2 shows an example of communication.

FIG. 3 shows and example of support frame according to present techniques.

FIG. 4 shows an example of a frame containing a synchronization information.

FIG. 5 shows an example of a synchronization information

FIGS. 6, 7, 8 show examples of syntax for communication elements

FIG. 9 shows an example of communication at the coordinator (base station)

FIG. 10 shows an example of first communication apparatus.

### DETAILED DESCRIPTION OF THE INVENTION

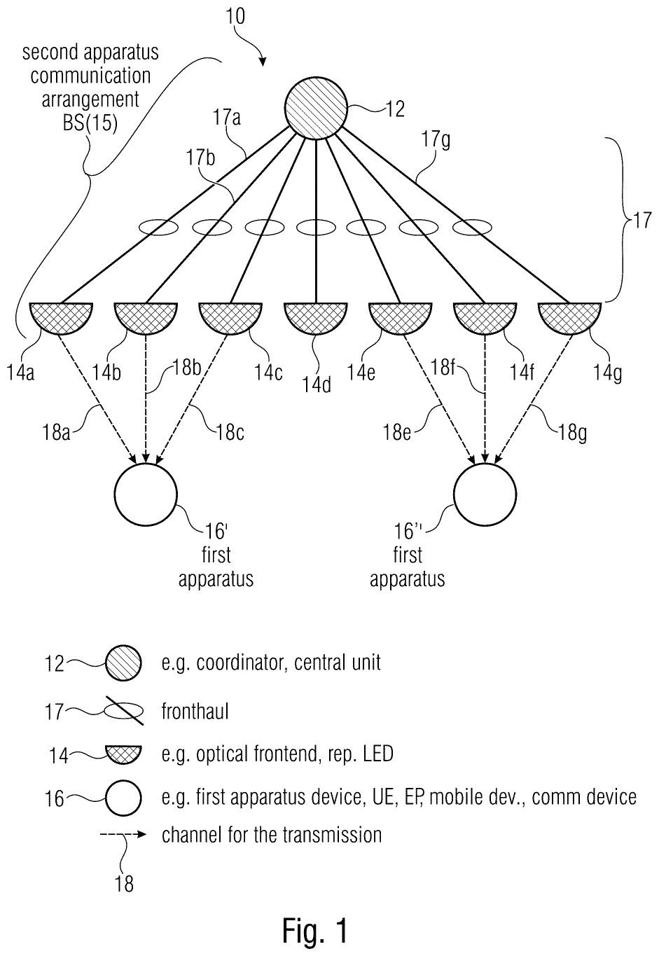

FIG. 1 shows a network 10 (also called OWPAN, from optical wireless personal area network, below, but which can be generalized to an optical network, or even a wireless network) for a wireless communication (e.g. light communication, or visible light communication, VLC) between at least one second communication apparatus, which is here a communication arrangement 15 (which may be, for example, a base station, BS), and at least one first communication apparatus. Here, the at least one first communication apparatus includes at least one communication device (e.g., user equipment(s), UE(s), relay endpoint(s), REPs, mobile device(s)).

The second communication apparatus (e.g. communication arrangement) 15 may include or be a coordinator 12, which may be a computer-based system (e.g. a processor-based system). The coordinator 12 may be understood, in some examples, as the (or an) intelligent part of the communication arrangement 15. In industrial automation examples, the coordinator 12 may also be part of a fixed equipment associated to some machinery or coordinating (or associated to a device coordinating) a plurality of machineries.

The second communication apparatus (communication arrangement) 15 may include at least one or a plurality of frontends (e.g., relay endpoints, REPs) 14a . . . 14g. The frontends 14a . . . 14g may be, for example, optical frontends (OFEs). In the case of OFEs, each OFE may include a photo transceiver, photo diode, transmitting diode, light emitting diode, LED. In case of RF, each frontend may include a RF transceiver. In case of ultrasound, each frontend may include an ultrasound transceiver.

In examples, a plurality of frontends 14a . . . 14g may be part of the communication arrangement 15. The optical frontends 14a . . . 14g may be spatially distributed (e.g. in known positions) so as to transmit and receive in different portions of an environment, so as to transmit/receive communications through channels (e.g., optical channels) 18a . . . 18g. In examples, the frontends 14a . . . 14g may have a position which is fixed and/or known.

The frontends 14a . . . 14g of the second communication apparatus 15 may be connected to the coordinator 12 through a fronthaul 17. The fronthaul 17 may be constituted by (or at least comprise) a communication channel(s) (e.g., 17a, 17b . . . 17g) for permitting transmissions between the frontends 14a . . . 14g and the coordinator 12. The fronthaul 17 may comprise at least one communication network. The fronthaul 17 may support a star topology. The fronthaul 17 may comprise a plurality of point-to-point connections. The fronthaul 17 may be wired (e.g. using metal conductors) or cabled (at least for some connections), at least for the connection with one frontend (in some examples, all the connections with the frontends are wired and/or cabled). In some examples, the fronthaul 17 is wireless (at least for the connection with one frontend).

Reference numerals 18a . . . 18g refer to optical channels (or more in general wireless channels) between the optical frontends 14a . . . 14g and the first apparatuses 16′ and 16″. The first apparatuses are also called first apparatus devices, user equipments (UEs), end points (EPs) mobile devices, or communication devices. As can be seen, a multiplicity of frontends may transmit (simultaneously) to the same first apparatus. For example, FIG. 1 shows that frontends 14a, 14b, 14c communicate, through channels 18a, 18b, 18c, respectively, with the first apparatus 16′, while the frontend 14e, 14f, 14g communicate, through the channels 18e, 18f, 18g respectively, with another first apparatus 16″.

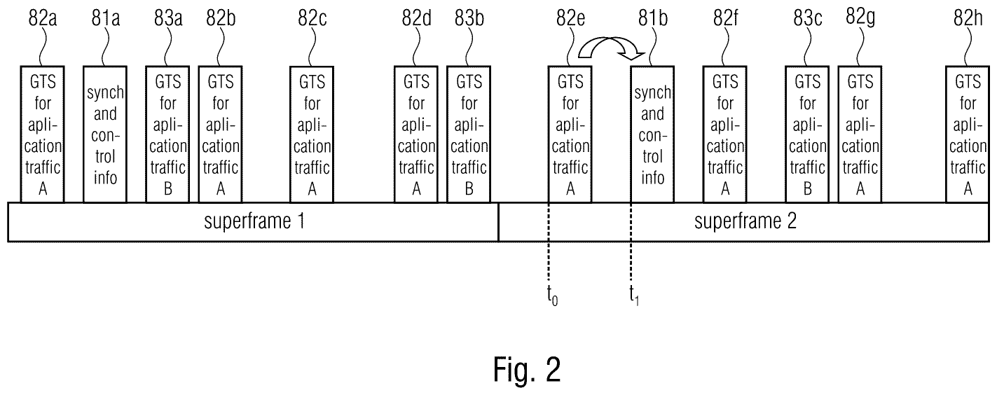

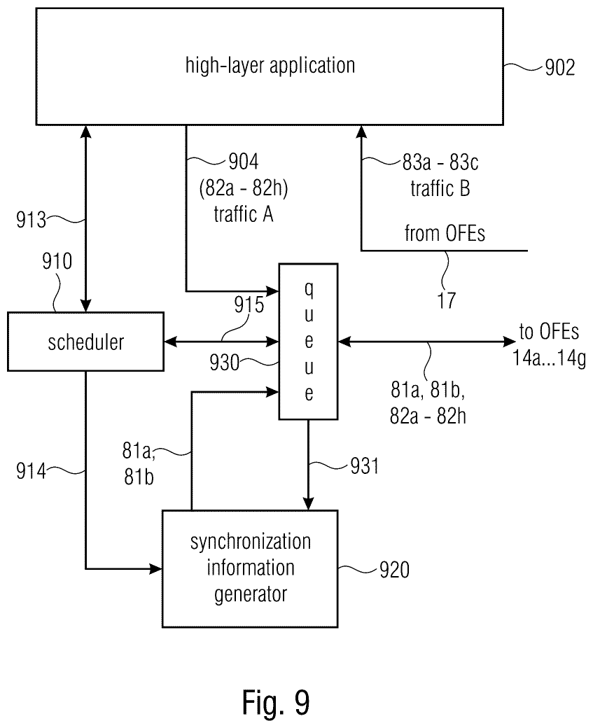

As it will be explained in greater detail later, the communications are here considered to be defined in superframes (e.g. each superframe occupying a span of time, e.g. without superposition of superframes, e.g. so that the end of a superframe ideally coincides with the start of an immediately subsequent superframe). FIG. 2 shows a superframe 1 and a superframe 2. Each superframe may be divided into a succession of slots (e.g. each slot occupying a span of time, e.g. without superposition of slots, e.g. so that the end of a slot ideally coincides with the start of an immediately subsequent slot). Each superframe may be understood as comprising a succession of mutually adjacent slots (e.g. a superframe may be constituted by an integer number of slots). All the slots may be understood to have the same time length (while it may be possible that different superframes have different time lengths), and the time length of the slots is in general known by both the first communication apparatus 16′, 16″ and the second communication apparatus 15. On the other side, it may be that different superframes have different length (and the length of each superframe, may be signalized, for example, e.g. by indicating, e.g. how may “synch slots” there are in each superframe, e.g. in a “synch slot” field of a synchronization element, also called “synch element”, see below). Multiple slots form a slice (e.g. each slice occupying a span of time, e.g. without superposition of slices, e.g. so that the end of a slice ideally coincides with the start of an immediately subsequent slice). Each superframe may be understood as comprising a succession of mutually adjacent slices (e.g. a superframe may be constituted by an integer number of slices). Different slices may have different length in number of slots, and this information may be signalized. In examples (e.g. in FIG. 2), each slice (also called “block”) may be assigned to a particular device (e.g., one of 12, 15, 16′, 16″) or to a particular application (e.g. to the higher-layer application 902, as shown in FIG. 9), the particular application running in a particular device (e.g., one of 12, 15, 16′, 16″). Some slices may be unused. The definition of the slices (e.g., identified by their slots, e.g. by the first slot of each slice) may be defined through scheduling, and may be signalized for example in a GTS descriptor element (see FIG. 8 and the related description) (The GTS descriptor element may be part of scheduling information 915). Therefore, a superframe may be considered to be constituted by some slices (e.g. as defined by the scheduling) and each slice may be considered to be subdivided in a succession of slots (e.g. equally long slots). FIG. 2 does not show the slots but shows slices which are assigned to particular granted communications. The granted communications are in the GTS (granted time slices). FIG. 2 shows that blocks 82a . . . 82h are assigned to the application traffic A, and the slices 83a, 83b, 83c are assigned to the application traffic B. It is here for the purpose of the present description, it is here a material to define whether the application traffic A and the application traffic B are in uplink (e.g., from the first apparatus device 16′ or 16″ to the coordinator 12) or (from the coordinator device 16 to the first apparatus device 16′ or 16″). For the purpose of discussing the present techniques here, it is in some examples immaterial whether the synchronization is performed in granted time slots (GTSs) (or granted time slices) or in random time slots (RTSs) (or random time slices). The GTSs (or granted time slices) are defined by a scheduler (e.g. 910, see below), while the RTSs (or random time slices) are sent (e.g. according to event-drive access) at non-predefined time slices. In examples, RTS may be planned by the scheduler 910 but transmissions of multiple devices (e.g. 16′, 16″, 15) may happen in RTS. In contrast, only a single device may transmit in a GTS (either the coordinator or a mobile device). In FIG. 2, slices 81a and 81b are occupied by synchronization information in downlink (e.g. from the coordinator 12 toward the first apparatus devices 16′ and 16″). It will be explained later that the synchronization information (81a, 81b) may take the form of a so-called “sync element”. The synchronization information 81a and 81b may include timing information (which is also called “sync slot”, or “sync slot field”, which indicates in which slot of the superframe the current synchronization information 81a or 81b starts, for example). The “sync slot field” provides therefore information on when the superframe begins (e.g. by informing in which slot of the superframe the present synchronization information 81a or 81b starts). The Sync element therefore informs the first device 16′ or 16″ about in which slot (e.g. the N-th slot) of the superframe (starting with slot 0) the frame containing the sync element is transmitted. Thus, the first device 16′ or 16″ can calculate back the beginning of the superframe (it is N slots before the slot in that the frame start lies).

For example, the sync element 81a may provide information on the timing in which the superframe 1 has begun, and analogous information may be provided by the sync element 81b.

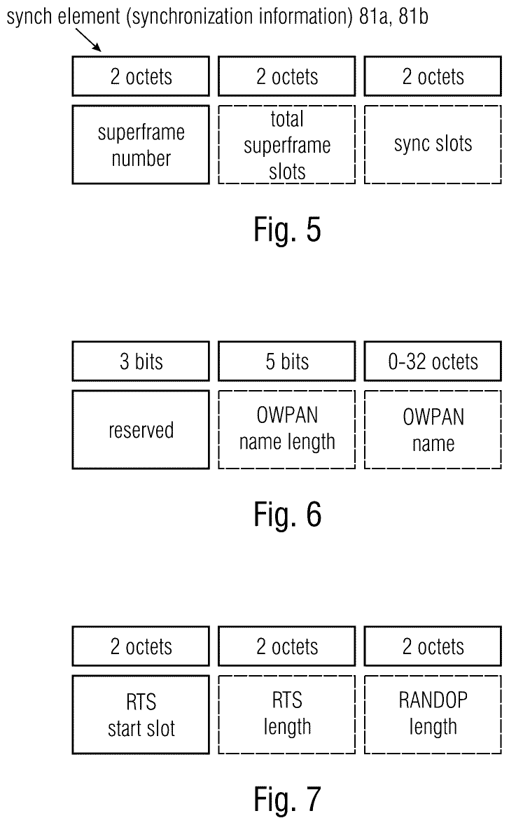

An example of sync element 81a, 81b (synchronization information) is provided in FIG. 5. In FIG. 5, there is shown, for example, that the superframe number (e.g., a progressive number which identifies the particular superframe) is encoded in a specific data field (which in the present example is shown as being encoded in two octets, but different bit lengths could be used (macNumSuperframeSlots)). The sync element (synchronization information) 81a, 81b may include an information on the number of total slots that are in the current superframe also indicated as being encoded into octets, but different bit lengths could be used (macNumSuperframeSlots) as seen in FIG. 5, the sync element (synchronization information) 81a, 81b, may include a “sync slot” (“sync slot field”). The sync slot (“sync slot field”) may be an example of timing information (in some examples, it may be understood that also the number of slots of the superframe and/or the superframe number can be considered as being part of the timing information). The sync slot may be used by the communication apparatuses 16′ and 16″ to synchronize their clocks to the clock of the coordinator 12. In fact, each of the first apparatus devices 16′ and 16″ may reduce the offset between its local clock and the time as indicated through the sync slot field (or more in general timing information) within the sync element (or more in general the synchronization information 81a and 81b). Just to give an example, in the example of the timing information 81b, there would be written an information which indicates t₁, i.e. the distance from the start of the superframe 2 (e.g. the number of slots from the first slot of the superframe to the first slot of the synchronization information 81b).

In most of the examples, the sync element (synchronization information) 81a, 81b is imagined to be sent at the very start of the superframe (and in that case, in the “sync slot field” there could be written “0”). However, for generality, the position of the sync element (synchronization information) 81a, 81b in the superframe could take a different temporal position.

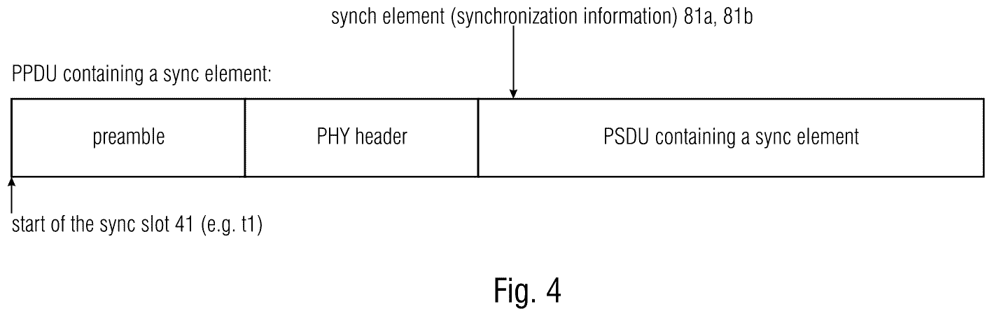

It is to be noted that the sync slot field may encode the temporal distance of the sync element from a reference time. The reference time may be, for example, the first slot of the current superframe (this choice for simplicity, also because the synchronization information 81a, 81b is often meant at being transmitted in the first slot of the superframe, and the common value of the “sync slot field” is normally expected to be “0”). The transmission of the synchronization information may provide the timing of a packet (e.g. of the preamble of the packet) comprising the synchronization information 81a, 81b, for example. Mostly in the examples the sync element (synchronization information) 81a, 81b is meant at being transmitted at the start of the superframe, most of the time the sync slot field will be occupied by a value which is 0. This does not happen in the example of FIG. 2 only because, for the sake of generality, we have preferred to indicate a different temporal position. Notwithstanding, it may be understood that the sync element 81b (synchronization information) will provide an indication of t₁ which may be the time distance from the start of the superframe 2 (t₁ may be indicated, for example, as the number of slots from the first slot of the superframe to the slot corresponding to the start of the sync element 81b). FIG. 4 shows a sync element 81a, 81b (synchronization information). Here we see that the sync element (synchronization information), 81a, 81b, may be encapsulated in a PPDU (physical protocol data unit) which includes a preamble, a physical header, and the PSDU which contains the sync element. As can be seen, the start of the sync slot (indicated with 41) is the progressive sync slot (from the first slot of the superframe) which the sync slot field (timing information) of FIG. 5 points to. So the start of the sync slot 41 may be for example, t₁ in the case of 81b. By taking into account the sync slot filed as in FIG. 5, (and, possibly, also the first apparatuses 16′ and 16″ may synchronize themselves with the clock of the coordinator 12).

It is to be noted, however, that in some examples it may be advantageous not to keep a fixed position for the sync element (or more in general synchronization information). As explained above, the transmission of the synchronization information (sync element) 81a, 81b could cause, in principle, a delay of important application transmission (e.g., scheduled or non-scheduled). For this reason, in some examples, it is advantageous not to keep a fixed position for the transmission of the sync element (e.g., not necessarily at the very first sync slot of the superframe) but, in some cases, it is advantageous to permit a mobile and definable positioning within the superframe. Let us assume, for example, that in FIG. 2 the sync element 81b should be transmitted at the time to. In that case, there would not be the possibility of transmitting the communication for the application traffic A indicated with 82e (payload data, e.g. requested by a higher-layer application e.g. 902, see below). In case of urgency of the communication 82e, the coordinator 12 may decide to delay the transmission of the sync element 81b so that it is transmitted, instead in the time instant t₀, in the subsequent time instant t₁. For the purpose of the synchronization, this is not a problem, since the time instant t₁ will be indicated in the sync slot field (as timing information) of the sync element 81b, instead of indicating the time instant t₀. The first communication apparatuses 16′ and 16″ will simply resynchronize by keeping into account the time distance of the start of the sync slot 41 (as indicated in the sync slot) with the start of the superframe 2 (when considered here as a reference time). For this reason, the synchronization between the coordinator 12 and the first communication apparatuses 16′ and 16″ will be granted, but also flexibility is achieved: it is admitted to selectably move the temporal position of the sync element in the more appropriate time slice, thereby reducing the impairment of the transmission of urgent communications. For the purpose of the present discussion, it is mostly immaterial to establish whether the transmission 82e is in uplink or a downlink. The transmission 82e may be an urgent, unscheduled transmission from the coordinator 12 towards the communication apparatuses 16′ and 16″, or it could be a scheduled transmission from one of the apparatuses 16′ and 16″ towards the coordinator 12. It is simply possible to see that the synchronization is maintained together without clogging fixed slices for control information at the expenses of high priority communication.

### Overview

This contribution aims to allow, e.g., light communication with real-time low-latency behavior, e.g., for time division multiple access (TDMA)-based medium access. The previously fixed structure (as defined, for example, in WO 2020/053235 A1) with a Beacon, CAP (collision avoidance period) and CFP (collision-free period) is broken down so that there is a general notion of Time Slices (TS), which are used to reserve resources for multiple purposes. As such, control information needed for network operation can be transmitted at arbitrary times within the TDMA superframe structure, allowing a scheduler (e.g. part of the coordinator) to place application data transmissions at the required times.

The contribution applies to networks (e.g., 10) that follow coordinated topologies, i.e., networks that consist of (or more in general comprises) member devices (e.g., 16′ and 16″) and one coordinator device (e.g., 12). The coordinator is responsible for allocating channel time to itself and the member devices in order to facilitate interference-free transmission.

The proposal provides deterministic transmission for the support of real-time data streams through its channel access mechanism. The configuration of data streams is out of scope of the present document and may require implementation-specific interfaces. Coordinators support registered streams by scheduling resources for transmissions accordingly.

The TDMA-based technology, with the proposed changes, provides flexible medium access schedules allowing for the support of isochronous traffic. The coordinator 12 and member devices 16′ and 16″obtain the characteristics of real-time application data streams through interfaces. The information contains one or more of the following: the periodicity of application data streams, the maximum allowed delay, the maximum allowed delay variation, the size of datagrams, the maximum allowed loss ratio of datagrams.

Different protocols exist to supply this information to the OWPAN devices (12, 16′ and 16″). Moreover, this information can be provided in an implementation-specific manner.

### TDMA-Based/Scheduled Medium Access

Optical networks (OWPANs) 10 make use of a scheduled medium access. The scheduled medium access relies on special frames (e.g., sync elements 81a, 81b, e.g., part of the PPDU of FIG. 4) to synchronize devices. The coordinator 12 allocates channel time for different ways of channel access. Deterministic channel access is supported in guaranteed time slices (GTS) and random channel access is supported in random time slices (RTS).

NOTE—RTS may be used, in some cases, only for certain purposes such as association and requesting additional channel time resources.

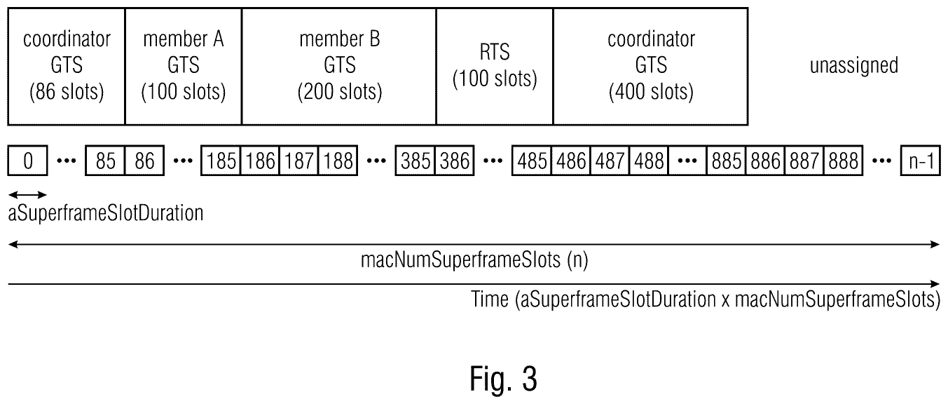

In TDMA, i.e., scheduled channel access mode, channel time may be divided into superframes (like in FIG. 2). Superframes are further divided into continuous groups of one or more slots, called time slices, as depicted in FIG. 3.

Time slices can be unassigned, assigned to a device as guaranteed time slice (GTS) or designated as random time slice (RTS). Assigning time slices is done by an implementation specific scheduler that is part of the coordinator 12. The scheduler (as part of the coordinator 12) may assign time slices for transmissions to the coordinator and to members 16′ and 16″.

During a GTS, devices 16′ and 16″ may (or in some examples shall) perform deterministic medium access according to the rules. During an RTS, devices 12, 16′ and 16″ may (or in some examples shall) perform random medium access.

When maintaining an OWPAN 10 with scheduled medium access, the coordinator 12 may (or in some examples shall) send frames containing the Sync elements (like 81a, 81b).

A superframe consists in (or more in general comprises) total of macNumSuperframeSlots superframe slots. macNumSuperframeSlots is a variable determined by the OWPAN coordinator and announced to the devices in the Sync element.

The superframe slot with the number zero may (or in some examples shall) be the first slot in the superframe (this is not the example of FIG. 2 can be without any problem).

The present techniques make use of integer numbers of superframe slots to specify durations within the superframe, e.g., the duration of a GTS or RTS.

Each of these time slices in the superframe might be in one of the following states for the duration of the current superframe:
Unassigned: No device may (or in some examples shall) transmit in these slots.
Assigned as GTS: The time slice was assigned to a device by the coordinator using a GTS descriptor element. The corresponding device 16′ or 16″ may (or in some examples shall) transmit during the GTS.
Assigned as RTS: These slots were assigned as RTS by the coordinator 12 using a RTS Descriptor element. During the RTS, devices 16′ and 16″ may access the channel randomly by means of slotted ALOHA.

Devices 12, 16′ or 16″ may (or in some examples shall) refrain from transmissions in superframe slots that were not assigned to it. This applies in particular, to the devices 16′ and 16″, which are not allowed to transmit transmissions in slots not assigned to them. In some cases, the coordinator 12 may transmit important transmissions (e.g., high-ranking transmissions) in unassigned slots.

### Synchronization of Member Devices (12, 16′, 16″) Through the Coordinator 12

All members (e.g., 16′ and 16″) be synchronized to a coordinators clock (e.g., a clock of the coordinator 12) and may (or in some examples shall) be synchronized to a coordinator's clock before they start transmission or reception. A Sync element (e.g., 81a, 81b) transmitted by the coordinator 12 enables synchronization of the members 16′ and 16″ for scheduled medium access through time of arrival synchronization.

The coordinator 12 may (or in some examples shall) maintain the value of macSuperframeNumber and increment it by one for every started superframe. The macSuperframeNumber value wraps to zero after reaching the maximum value (e.g., which is a number associated with the two octets but different bit lengths could imply different maximum values). (65535).

The coordinator 12 may (or in some examples shall) transmit a frame (e.g., shown in FIG. 4) containing a Sync element (e.g., 81a, 81b) via each OFE (14a . . . 14g) in a suitable time slice with an implementation specific rate but at least every aMacMinSyncinterval. The frame's receiver address may (or in some examples shall) be the broadcast address. The frame may (or in some examples shall) contain the current macSuperframeNumber, the number of slots contained in the superframe (e.g., as shown in FIG. 5), and the number of the slot in which the frame containing the Sync element (e.g., 81a, 81b) was transmitted (e.g., t₁ in FIG. 2 as indicated in the Sync slot as shown in FIG. 5). The coordinator may (or in some examples shall) start transmitting the frame at the start of the superframe slot.

Upon reception of a Sync element (e.g., 81a, 81b), members 16′ and 16″, may (or in some examples shall) set their value of macSuperframeNumber and macNumSuperframeSlots to the value in the received Sync element. Moreover, members 16′ and 16″ may (or in some examples shall) synchronize their clocks to the received Sync element 81a, 81b by reducing the offset between their local clock and time indicated through the Sync Slot field within the Sync element (e.g., to less than aPhyOfeSyncAccuracy).

If no Sync element 81a, 81b is received during the duration of a superframe, devices 16′ and 16″ may (or in some examples shall) assume that the value specified for macNumSuperframeSlots in the last received Sync element is still valid and increase macSuperframeNumber at the time the next expected superframe starts. Accordingly, the present technique tolerates the situations in which no sync element 81a, 81b is transmitted at all, thereby increasing the reliability.

If a Sync element 81a, 81b is not received within aMacMinSyncInterval, devices 16′ and 16″ may (or in some examples shall) keep listening for the next Sync element in order to synchronize before attempting further transmissions. Devices 16′ and 16″ may be considered not synchronized after more than 2*aMacMinSyncInterval has passed without reception of a Sync element.

### Random Access in RTS

RTS may (or in some examples shall) only be used for transmissions from devices to the coordinator in the
a) Association procedure.
b) GTS request procedure.

The slotted Aloha scheme may be used for contention-based access in RTS. Superframe slots in RTS are grouped in so-called RANDOPS, which comprise RANDOP Length superframe slots each. The number of superframe slots per RANDOP determines the slot size for the slotted Aloha scheme and hence the effectiveness of collision prevention. The value of RANDOP Length is advertised in the RANDOP Length field of the RTS Descriptor element.

RTS are signaled through RTS Descriptor elements, transmitted from the coordinator to members. For each received RTS Descriptor element, the corresponding RTS may (or in some examples shall) start with the superframe slot given in the RTS Descriptor element and end after the number of slots given in the RTS Length field has passed.

The number and duration of RTS might be varied by the coordinator in order to allow more or less random-access transmissions in a superframe.

NOTE—The coordinator 12 should transmit a frame containing a RTS Descriptor element regularly in order to allow associations and prevent members 16′ and 16″ running out of transmit resources unnoticed.

Devices request additional resources during a GTS. However, when a device does not have any or only insufficient GTS time allocated to perform a GTS request, it may make use of an RTS to transmit a GTS Request element to the coordinator

### Scheduled Medium Access in GTS

GTS allow channel access based on the Time-Division Multiple Access (TDMA) principle.

The coordinator 12 may perform transmissions to a device 16′ and 16″ at any point in the superframe, except when the device has a time slice assigned (half-duplex).

If the coordinator 12 has control over multiple spatially distributed OFEs 14a . . . 14g, it may allocate the same superframe slots in different GTS or RTS for multiple spatially distant devices 16′ or 16″ in order to facilitate spatial reuse of superframe slots within the OWPAN's coverage area. The coordinator 12 should, in some examples, allocate GTS and RTS in a way that transmissions in RTS do not interfere with transmissions in GTS.

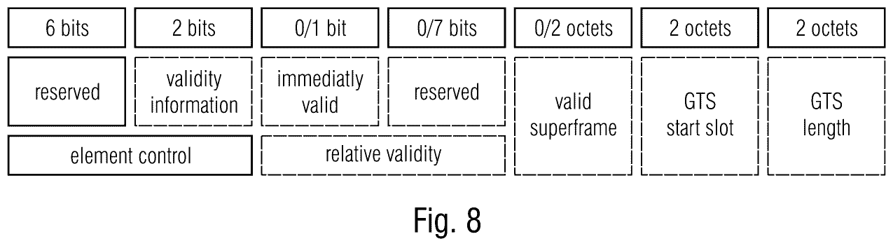

All members 16′ and 16″, whether they are associated with a scheduled OWPAN 10 or attempting association, may (or in some examples shall) be synchronized to the coordinator's clock before they start transmission or reception. The frame (e.g., shown in FIG. 4) that contains a Sync element 81a, 18b (e.g., shown in FIG. 6) enables synchronization of the devices 16′ and 16″ in the scheduled OWPAN 10 through time of arrival synchronization.

Members 16′ and 16″ may (or in some examples shall) assume that the start 41 of the preamble of the PPDU that carries a Sync element 81a, 81b corresponds to the start time of the Sync Slot as specified in the Sync element. Therefore, the superframe starts Sync Slot slots before the start of the preamble. All superframe slots and hence timings within the superframe are relative to the calculated start of the superframe.

To prevent collisions between transmissions of different devices, there is a guard time between successive GTS. Its duration is calculated from the clock accuracy and the rate of sync element transmissions as follows:

$$MaxDrift = aClockAccuracy * SyncInterval ,$$

Where aClockAccuracy is a MAC constant and SyncInterval is the interval between Sync element transmissions and hence the periodicity of the synchronizing event.

The coordinator may (or in some examples shall) allocate GTSs with the constraint that a guard time of at least

$$2 * ( MaxDrift + aPhyOfeSyncAccuracy ) ,$$

lies between two subsequent GTS that are not orthogonal in space.

### OWPAN/Network Announcement

The coordinator 12 may (or in some examples shall) start transmitting an Announcement element in a suitable time slice at least every aMaxAnnouncementPeriod.

The Announcement element may (or in some examples shall) contain the current values of the OWPAN name and OWPAN name length.

If multiple OFEs 14a . . . 14g are used by the coordinator 12, frames containing Announcement elements may (or in some examples shall) be transmitted over all OFEs 14a . . . 14g.

Before association is attempted in an RTS, the device 16′ and 16″ may (or in some examples shall) wait for the reception of an Announcement element. Upon reception of an Announcement element, devices 16′ and 16″ may (or in some examples shall) update their value of OWPAN Name to the values in the received Announcement element. Furthermore, the device may (or in some examples shall) apply changed values from any attribute change request elements contained in the same frame as the Announcement element. The values contained in the Announcement element are required for association with the OWPAN 10.

### Information Carrying Frames and Elements

We assume that the light communication system uses a frame format that starts with a preamble and PHY header at the physical layer, followed by a second MAC-layer header and a payload. The MAC header discriminates the payload type, and the actual payload consists of (or more in general comprises) one or more elements.

### Sync Element

The Sync element or more in general, synchronization information 81a, 81b is depicted in FIG. 5, is used to transmit synchronization information from the coordinator 12 to members 16′ and 16″ as part of the scheduled medium access, defined in FIG. 6.

Superframe Number: The number of the current superframe that the frame containing the Sync element was transmitted in.

Total Superframe Slots: The total number of slots contained in the current superframe.

Sync Slot (or more in general a timing information): The slot in that the preamble of the frame that contained the Sync element was transmitted in.

The example of FIG. 5 has already been discussed and its fields are here above rewritten. Announcement element

The Announcement element, depicted in FIG. 6, serves announcing the OWPAN as part of the OWPAN maintenance procedure.

OWPAN Name Length: The length of the subsequent OWPAN Name field in octets.

OWPAN Name: A human-readable network name, encoded as UTF-8 string. The string may (or in some examples shall) include no null-byte at any location.

NOTE—OWPAN IDs may be bitwise different but appear to be the same to humans due to possible homoglyphs in the UTF-8 encoding.

### RTS Descriptor Element

The RTS Descriptor element, depicted in FIG. 7, describes a single RTS allocation in the beacon-enabled channel access mode.

RTS Start Slot: This field specifies the first slot of the allocated RTS.

RTS Length: This field specifies the duration of the RTS in superframe slots.

RANDOP Length: This field specifies the number of slots in a RANDOP during the described RTS.

Validity Information: This field indicates how the validity information for the GTS is signaled. See below for how to interpret the contained values.

Immediately Valid: If the field is set to one the GTS becomes effective in the same superframe, the GTS Descriptor element was received. Otherwise, the GTS becomes effective in the following superframe. This field is only present if Validity Information equals zero.

Valid Superframe: This field specifies the superframe in that the GTS is valid. It is only present if Validity Information equals one.

GTS Start Slot: This field specifies the first slot of the allocated GTS.

GTS Length: This field specifies the duration of the GTS in superframe slots.

### Constants

A constant aMaxAnnouncementPeriod defines that announcements has to be sent at least every second.

It is defined that aPhyOfeSyncAccuracy defines the maximum deviation of the real transmit time at the optical emitter from the nominal transmit time as intended by the MAC.

A constant aMacMinSyncInterval with a value of 1 s defines the minimum rate of Sync element transmissions for each OFE.

### Other Aspects

The second communication apparatus 15 [e.g. master communication apparatus, communication arrangement, base station, or coordinator, or scheduler] may transmit control signalization. [Control signalization may include scheduling information, and/or synchronization information (e.g. including the timing information)] [the scheduling information may include the GTS descriptor element and/or RTS descriptor elements] [multiple control signalizations may be transmitted in at least one packet; they may be distinguished through various techniques, e.g. by using different preambles, or anyway different unique sequences, for each control signalization].

At least part of the control signalization may be transmitted in GTS exclusively assigned to the second communication apparatus 15 [e.g. master communication apparatus, communication arrangement, base station, or coordinator, or scheduler]. However, in examples control singalization (and in particular the synchronization information 81a, 81b) may be event-driven (e.g. transmitted only in case it is necessary, without necessarily scheduling it). (e.g., it may be transmitted in a different channel only to be used for transmitting at least some control signalization, and/or in at least one RTS; in some examples, the other communication apparatuses may be remaining waiting for receiving transmissions from the communication apparatus during the non-assigned time slots, and the communication apparatus may therefore occupy the non-assigned slots to transmit at least some control signalization event-driven, without necessarily scheduling those event-driven control signalization(s))

The control signalization may be transmitted, for example, event-driven, in cases in which an application frame is to be urgently transmitted and/or received. For examples, in one example according to FIG. 2, the data transmissions 82a-82h (traffic A, e.g. assigned to a first communication apparatus 16′) and the data transmissions 83a-83c (traffic B, e.g., e.g. assigned to another first communication apparatus 16″) are scheduled, while the control signalizations 81a and 81b may be event-driven, and transmitted in slots which are non-assigned to any transmission (and therefore the second communication apparatus 15 has the privilege of transmitting the control signalizations 81a and 81b in those non-assigned slots). Notably, the scheduling in the superframe 2 may be defined by the control signalization 81a transmitted in the superframe 1. Internally, the second communication apparatus 15 [e.g. master communication apparatus, communication arrangement, base station, or coordinator, or scheduler] may foresee to transmit the control signalization 81b in the time slot to. However, in view of the high ranking urgency of data transmission 82e, the data transmission 82e takes over and the control signalization 81b may be delayed to the time slot t₁. In case the control signalization 81b also includes the timing element, if this is instantiated by the data value “SynchSlot”, that value will be updated (for example, instead of to, there will be encoded t₁)

It is to be noted that FIG. 2 also apply to the case in which the control signalization 81b is actually scheduled to be transmitted at slot to. In this case, the shifting applies in any case. If it only sent, in the scheduling information in the control signalization 81a, that the slots starting from to will be assigned for traffic A and for transmission 82e.

In examples above, the second communication apparatus 15 [e.g. master communication apparatus, communication arrangement, base station, or coordinator, or scheduler] may be connected (or include) a higher-layer application. The higher-layer application may define characteristics of real-time application data streams through interfaces. The information may contain one or more of the following: the periodicity of application data streams, the maximum allowed delay, the maximum allowed delay variation, the size of datagrams, the maximum allowed loss ratio of datagrams. For example, in the example of FIG. 2, the maximum allowed delay of traffic A (in particular of the transmission 82e may require the rescheduling of the transmission 82e to time slot to, thereby causing the shifting of the control signalization 81b to the time slot t₁.

(In some examples, when a transmission is “at t₀ it is meant that “it starts at t₀”, for example).

### An Example of Communication at the Coordinator 12

An example of communication at the coordinator 12 (or more in general at the base station 15, or second apparatus communication arrangement) is shown in FIG. 9. Here there is shown a high-layer application 902 which exchanges data with first apparatuses 16′ and 16″ through OFEs 14a, . . . , 14g, (as shown in FIG. 1). In particular, data A (traffic A) transmitted in some particular slices (GTS) 82a, . . . , 82h in downlink and other data B (traffic B) are received in the GTS slices 83a-83c, following the example of FIG. 2. A scheduler 910 (which allocates the different slices to the different traffics A and B and/or allocates different slices, i.e. consecutive slots, to different devices) exchanges control data 913 with the high layer application 902. Scheduling information 915 may therefore be provided to the first apparatuses 16′, 16″ (e.g. informing on which slice is associated with which of the devices 15, 16′, 16″). A synchronization information generator 920 (which generates the sync elements 81a, 81b, or more in general signalization information, or even the message of FIG. 4 which contains the sync elements 81a, 81b) is indicated with 920. The synchronization information 920 may exchange control information with the scheduler 910. FIG. 9 shows a queue 930 onto which data for the slices 82a, . . . , 82h (traffic A) and the synchronization information 81a, 81b is received from the high-layer application 902 and the synchronization information generator 920, respectively. From the queue 930, the data for the slices 82a, . . . , 82h and the synchronization information 81a, 81b may be transmitted through the frontends 14a, . . . , 14g to the first apparatuses 16′, 16″. Feedback information 931 may be received by the synchronization information generator 920 from the queue 930. In this example, keeping into account the example of FIG. 9, each superframe is scheduled (e.g. as shown in FIG. 2). This means that the Sync element 81a is generated by the synchronization information generator 920 and encapsulated and provided to the queue 930 and transmitted through the OFEs 14a . . . 14g according to the timing defined by the scheduler 910. In the superframe 2 of FIG. 2, the synchronization information generator 920 refrains from transmitting the Sync element 81b at the time instant t₀, to permit the transmission of the urgent data (traffic A) in time slot 82e. Notwithstanding, the synchronization information 81b is transmitted at the time instant t₁. As explained above, however, in the timing information (e.g. “sync slot field”) of the sync element 81b an indication is provided informing on the time instant t₁ (while no information is provided on instant t₀). It is to be noted that this example is only one of the possibilities. In particular, the feedback 931 is shown as being provided from the queue 930 to the synchronization information generator 920, but this could also not be the case: the scheduler 930 could decide the scheduling (including the scheduling of the Sync element 81b), without the necessity of having any feedback 931 form the queue 930 (but e.g. having information of urgency from the high-layer application 902). Notably, the transmission of the Sync element 81a, 81b may be performed without any problem in downlink, and in that case, it is the scheduler 910 that needs to schedule a GTS for the data to be received in the GTS slice 82e. The synchronization information generator 920 and the scheduler 910 may be connected (914), so that the schedule may dynamically perform a rescheduling which keeps into account the feedback 931, for example.

Basically, it is here not vital whether the data to be transmitted at the slot to is in uplink or downlink, or is a scheduled data or non-scheduled data: it is important that the synchronization information 81b is transmitted at a time which can be selectively decided by the coordinator 12, but still permits the synchronization of the second apparatuses 16′ and 16″, increasing the flexibility (but not at the expense of the reliably).

The higher-layer application 902 may provide to the second communication apparatus 15 information on characteristics of real-time application data streams (e.g. through interfaces). The information on characteristics of real-time application data streams may contain one or more of the periodicity of payload data of the application data streams. Therefore, the coordinator 12 will know how many times per superframe the payload data shall be sent and/or received. The information on characteristics of real-time application data streams may contain the maximum allowed delay (e.g. maximum allowed delay variation) for the transmission of the of payload data of the application data streams. Therefore, the coordinator 12 knows whether it is allowed to delay a transmission of payload data or whether it is advantageous to delay another data: for example, in FIG. 2, probably the payload data (traffic A) 82e cannot be delayed (e.g. by virtue of the maximum allowed delay for the transmission of the of payload data), and therefore it is advantageous to delay the transmission of the sync element (synchronization information) 81b. In a variant, instead of the maximum allowed delay there may be the maximum allowed loss ratio [e.g. of datagrams]. The information on characteristics of real-time application data streams may contain (or may provide information which permits to understand) how many times per superframe the payload data shall be sent and/or received. Accordingly, the scheduler 910 may generate the scheduling to allow the transmission of the particular payload data.

In some examples, if the information on the characteristics of real-time application data streams requires a particular maximum latency for the transmission and/or reception of a particular transmission (e.g. from a UE and/or to the UE), time slots, which are not scheduled for a particular different communication apparatus (e.g. UE), may be awarded to the different first communication apparatus (e.g. by quickly rescheduling on-the-fly), and/or other transmissions from the communication apparatus (e.g. control signalizations) may be shifted towards subsequent time slots. [this may occur, for example, in case the higher-layer application specifies some payload transmissions as having a high ranking urgency].

As such, the operations of the scheduler 910 may be considered be known. However, in some cases, there is the possibility of defining the scheduling based on some feedback. For example, it is possible to operate the scheduling so that:
in case of comparatively higher traffic congestion, reducing the amount of time slots for the transmission of control signalization and/or increasing the amount of granted time slots assigned to at least one of the different communication apparatuses; and/or
in case of comparatively lower traffic congestion, increasing the amount of time slots for the transmission of control signalization and/or reducing the amount of granted time slots assigned to at least one of the different communication apparatuses.

The traffic congestion may be measured, for example, by measuring round-trip latency times and/or error rates, for example.

In addition or alternatively, there is the possibility of ranking the urgency of the transmissions and/or receptions is ranked according to an urgency ranking, so that:
in case of comparatively higher ranking transmissions and/or receptions, reducing the amount of time slots for the transmission of control signalization and/or increasing the amount of granted time slots assigned to at least one of the different communication apparatuses; and/or
in case of comparatively lower ranking transmissions and/or receptions, increasing the amount of time slots for the transmission of control signalization and/or reducing the amount of granted time slots assigned to at least one of the different communication apparatuses.

### An Example of First Communication Apparatus 16′, 16″

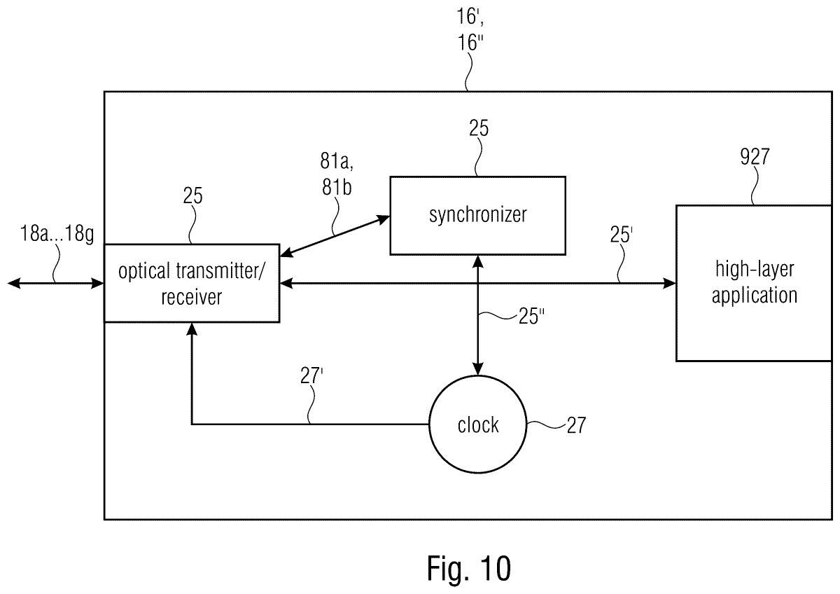

FIG. 10 shows an example of a first communication apparatus 16′ or 16″ of FIG. 1. As can be seen, the first communication apparatus 16′, 16″ may include an optical (or more in general wireless) transmitter/receiver 25. The wireless (e.g. optical) transmitter/receiver 25 may be optically connected (or more in general, wirelessly connected) with the (e.g. optical) frontends 14a . . . 14g (e.g., through the optical connections, or more in general wireless connections, 18a . . . 18g). The transmitter/receiver 25 may be internally connected (e.g., through the line 25′, e.g. a wired line) with the higher layer application 927. The higher layer application 927 may therefore exchange payload data with the high-layer application 902 of the second apparatus 15 (and in particular the coordinator 12) through the network 10 (e.g. OWPAN). FIG. 10 shows that an internal clock 27 is present in the first communication apparatus 16′, 16″. It is possible to synchronize, e.g., through the clock signal 27′, the optical transmitter/receiver 25. Basically, the clock 27 may define the time length of each slot, so that the scheduled transmissions/receptions of the transmitter/receiver 25 follow the synchronism provided by the clock signal 27′. The internal clock 27 may be in turn synchronized to a clock of the coordinator 12 (second communication apparatus 15) through a synchronization control 25″. The synchronization control 25″ may be outputted, for example, by a synchronizer 25. The synchronizer 25 may receive the synchronization information (sync element) 81a, 81b from the coordinator 12 (second communication apparatus 15).

The synchronizer 25 may count, as explained above, the number of slots between the current reference time (e.g. the start of the superframe) and the start (e.g. first slot of the preamble) of the sync element (synchronization information), and compare the counted number of slots with the number encoded in the “synch slot field” (timing information). In view of the comparison, the synchronizer 25 may calculate a drift (offset) and compensate for it by adjusting the timing to the value written in the “synch slot field” (timing information). As explained above, the current reference time is often imagined to be the time instant in which the superframe starts, i.e., the first slot of the superframe. (The synchronizer 25 may update the knowledge of the time by controlling, through the control 25″, the clock 27).

It is to be noted that the synchronization at the first communication apparatus 16′, 16″ may be performed by evaluating, from the timing information (e.g. “sync slot field”), a time distance between the timing information as encoded and the timing reference (e.g. reference time) as measured. In case of drift (offset) between the timing information as encoded and the timing reference (e.g. reference time) as measured, it is possible for the communication apparatus 16′, 16″ to adjust the internal clock to the timing information as encoded.

### Examples Regarding the Second Communication Apparatus 15 (Coordinator 12)

In examples above (e.g., in FIGS. 1 and 9) there is disclosed a communication apparatus 15 (coordinator 12) [e.g. communication arrangement, base station, coordinator, scheduler, etc.] [e.g. for a wireless communication, e.g. optical communication or RF communication] wherein the communication apparatus is configured to transmit and/or receive [e.g. in a superframe] a plurality of packets using a scheduling [e.g. defined by an (individual) assignment of slots (or slices, which may comprise a plurality of slots) in a superframe to different communication apparatuses (e.g. designated as “GTS”) and/or defined by an assignment of slots (or slices) to a random transmission (e.g. designated with “RTS”)] related to a reference time [e.g. a beginning of a superframe; e.g. a first slot of a superframe, the reference may be periodical, but in alternative it can change; notwithstanding the reference time can be updated for a new superframe];
wherein the communication apparatus is configured to transmit a synchronization information [e.g. having a variable timing with respect to the reference time] [e.g. for different superframes the synchronization information may be transmitted in different timings (e.g. delays) relative to the reference time];
wherein the communication apparatus is configured to include [e.g. encoded in a data field] into the synchronization information [e.g. into the sync element] a timing information [e.g. a “sync slot” information; e.g. an information at which slot of a superframe a frame comprising the synchronization information begins] defining [and/or describing] a timing of the transmission of the synchronization information [e.g. a timing of a preamble of a packet comprising the synchronization information] with respect to [e.g. relative to] the reference time [e.g. with respect to a first slot of a current superframe].

The second communication apparatus 15 (or the coordinator 12) may be configured to include, in the timing information, a time distance [e.g. in time slots] from the transmission of the synchronization information [e.g. the timing of a preamble of the packet comprising the synchronization information] and the reference time.

The second communication apparatus 15 (or the coordinator 12) may be configured to include, a timing information, information on the time distance from the reference time to the next timing reference [e.g. “total superframe slots”].

The second communication apparatus 15 (or the coordinator 12) may be configured to provide scheduling information to the different communication apparatuses [e.g. UEs] assigning exclusive time slots to each of the different communication apparatuses.

The second communication apparatus 15 (or the coordinator 12) may be configured to provide, to the different communication apparatuses [e.g. UEs], scheduling information assigning exclusive time slots [e.g., one slice, which comprises a plurality of slots, e.g. a plurality of consecutive slots] to the communication apparatus for the transmission of at least some control signalization [control signalization includes scheduling information, synchronization information (including the timing information)] [the scheduling information may include the GTS descriptor element and/or RTS descriptor elements] [multiple control signalizations may be transmitted in at least one packet; they may be distinguished through various techniques, e.g. by using different preambles, or anyway different unique sequences, for each control signalization] [e.g. in some examples, the transmission of a control signalization may delayed, e.g. in view of the necessity of a transmission or reception of a payload data, e.g. like the control signalization 81b being shifted from t₀ to t₁ in FIG. 2; this may occur, for example, in case of necessity of addressing a requirement set out by a higher-layer application].

The second communication apparatus 15 (or the coordinator 12) may be configured to further transmit at least some control signalization event-driven (e.g., in a different channel and/or in time slots only granted to for transmitting at least some control signalization, and/or in at least one RTS; in some examples, the first communication apparatuses 16′, 16″ may be remaining waiting for receiving transmissions from the second communication apparatus 15 during the non-assigned time slots, and the second communication apparatus 15 may therefore occupy the non-assigned slots to transmit at least some control signalization event-driven, without necessarily scheduling those event-driven control signalization(s)) [in the example of FIG. 2, it may be that the control signalization 81b is delayed (shifted towards later time), but this in some examples does not necessarily requires a scheduling to be defined and provided to the other different communication apparatuses, because the new time slots which are now occupied by the control signalization 81b were not assigned to any of the other communication devices 15, 16′, 16″] [control signalization may include scheduling information, synchronization information (including the timing information)] [the scheduling information may include the GTS descriptor element and/or RTS descriptor elements] [multiple control signalizations may be transmitted in at least one packet; they may be distinguished through various techniques, e.g. by using different preambles, or anyway different unique sequences, for each control signalization] [e.g. in some examples, the transmission of an event-driven control signalization may delayed, e.g. in view of the necessity of a transmission or reception of a payload data, e.g. like the control signalization 81b being shifted from t₀ to t₁ in FIG. 2; this may occur, for example, in case of necessity of addressing a requirement set out by a higher-layer application].

The second communication apparatus 15 or coordinator 12 may be configured to delay the transmission of a control signalization (81b) [whether scheduled or even-driven] [e.g. from t₀ to t₁] in case a higher-layer application requires the transmission and/or reception of a transmission [e.g. a payload frame from or to a UE, different communication apparatus] [e.g. the communication apparatus may therefore delay the transmission 81b of a control signalization, e.g. towards the first next slice (group of consecutive time slots) which is free (e.g., not assigned to any of the other, different communication apparatuses and/or not used at all)].

The second communication apparatus 15 or coordinator 12 may be such that the control signalization includes [e.g. has encoded therein] scheduling information for the subsequent transmissions (e.g. for the subsequent superframes).

The second communication apparatus 15 or coordinator 12 may be such that the control signalization includes [e.g. has encoded therein] the synchronization information for the subsequent transmissions (e.g. for the subsequent superframes).

The second communication apparatus 15 or coordinator 12 may be such that the control signalization includes [e.g. has encoded therein] announcement information [e.g. in which there is encoded information human-readable information, such as encoded in UTF-8 string, ASCII code, etc.].

The second communication apparatus 15 or coordinator 12 may be such that the control signalization includes [e.g. has encoded therein] random access timing information [e.g. being or including a RTS descriptor element], providing information on slots [e.g. in respect to the reference time] which are grant-free.

The second communication apparatus 15 or coordinator 12 may be such that the control signalization includes [e.g. has encoded therein] granted access timing information [e.g. being or including a GTS descriptor element], providing information on time slots [e.g. in respect to the reference time] which are grant-free.

The second communication apparatus 15 or coordinator 12 may be configured to define the scheduling information [e.g. for future transmissions, e.g. after future time reference(s)] by keeping into account traffic

The second communication apparatus 15 or coordinator 12 may define the scheduling information [e.g. for future transmissions, e.g. after future time reference(s)] by:
in case of comparatively higher traffic congestion, reducing the amount of time slots for the transmission of control signalization and/or increasing the amount of granted time slots assigned to at least one of the different communication apparatuses; and/or
in case of comparatively lower traffic congestion, increasing the amount of time slots for the transmission of control signalization and/or reducing the amount of granted time slots assigned to at least one of the different communication apparatuses.

The second communication apparatus 15 (or the coordinator 12), wherein the urgency of the transmissions and/or receptions is ranked according to an urgency ranking, wherein the communication apparatus is configured to
in case of comparatively higher ranking transmissions and/or receptions, reducing the amount of time slots for the transmission of control signalization and/or increasing the amount of granted time slots assigned to at least one of the different communication apparatuses; and/or
in case of comparatively lower ranking transmissions and/or receptions, increasing the amount of time slots for the transmission of control signalization and/or reducing the amount of granted time slots assigned to at least one of the different communication apparatuses.

The second communication apparatus 15 or coordinator 12 may be configured to define the scheduling by reinstating the time slots for the transmission [partial or in full] of the control signalization in case of a threshold condition is reached [e.g. when it is not possible anymore to refrain from transmitting control signalization].

The second communication apparatus 15 or coordinator 12 may further comprise a plurality of frontends [e.g. relays] configured to simultaneously transmit and/or receive different packets through the different frontends.

The second communication apparatus 15 or coordinator 12 may be configured to selectively simultaneously transmit synchronization information [or more in general different control signalizations] in different time slots for different frontends [e.g. the scheduling may be varied for different frontends, and the situations above may be applied for each frontend, while simultaneously other frontends experience different situations].

The second communication apparatus 15 or coordinator 12 may include or be connected to a higher-layer application, the communication apparatus using information on characteristics of real-time application data streams (e.g. through interfaces) from the higher-layer application. [The information on characteristics of real-time application data streams may contain one or more of the following: the periodicity of application data streams, the maximum allowed delay, the maximum allowed delay variation, the size of datagrams, the maximum allowed loss ratio of datagrams].

The second communication apparatus 15 or coordinator 12 may be configured to use the information on the characteristics of real-time application data streams, e.g. in such a way that, if the information on the characteristics of real-time application data streams requires a particular maximum latency for the transmission and/or reception of a particular transmission (e.g. from a UE and/or to the UE), time slots, which are not scheduled for a particular different communication apparatus (e.g. UE), are awarded to the different communication apparatus (e.g. by quickly rescheduling on-the-fly), and/or other transmissions from the communication apparatus (e.g. control signalizations) are shifted towards subsequent time slots. [this may occur, for example, in case the higher-layer application specifies some payload transmissions as having a high ranking urgency].

In examples above (e.g., in FIGS. 1 and 9) there is shown a communication method [e.g. in downlink, from a communication arrangement, base station, coordinator, scheduler, etc. to a user equipment, a mobile device, etc.] [e.g. for a wireless communication, e.g. optical communication or RF communication], comprising: transmitting and/or receiving [e.g. in a superframe] a plurality of packets using a scheduling [e.g. defined by an (individual) assignment of slots (or slices, which may comprise a plurality of slots) in a superframe to different communication apparatuses (e.g. designated as “GTS”) and/or defined by an assignment of slots (or slices) to a random transmission (e.g. designated with “RTS”)] related to a reference time [e.g. a beginning of a superframe; e.g. a first slot of a superframe, the reference may be periodical, but in alternative it can change; notwithstanding the reference time can be updated for a new superframe];
the method further comprising transmitting a synchronization information [e.g. having a variable timing with respect to the reference time] [e.g. for different superframes the synchronization information may be transmitted in different timings (e.g. delays) relative to the reference time]; wherein transmitting a synchronization information comprises including [e.g. encoding in a data field] into the synchronization information [e.g. into the sync element] a timing information [e.g. a “sync slot” information; e.g. an information at which slot of a superframe a frame comprising the synchronization information begins] defining [and/or describing] a timing of the transmission of the synchronization information [e.g. a timing of a preamble of a packet comprising the synchronization information] with respect to [e.g. relative to] the reference time [e.g. with respect to a first slot of a current superframe].

There is also disclosed a non-transitory storage unit storing instructions which, when executed by a processor, cause the processor to:
control the transmission and/or reception [e.g. in a superframe] of a plurality of packets using a scheduling [e.g. defined by an (individual) assignment of slots (or slices, which may comprise a plurality of slots) in a superframe to different communication apparatuses (e.g. designated as “GTS”) and/or defined by an assignment of slots (or slices) to a random transmission (e.g. designated with “RTS”)] related to a reference time [e.g. a beginning of a superframe; e.g. a first slot of a superframe, the reference may be periodical, but in alternative it can change; notwithstanding the reference time can be updated for a new superframe];
control the transmission of a synchronization information [e.g. having a variable timing with respect to the reference time] [e.g. for different superframes the synchronization information may be transmitted in different timings (e.g. delays) relative to the reference time];
wherein the synchronization information comprises including [e.g. encoding in a data field] into the synchronization information [e.g. into the sync element] a timing information [e.g. a “sync slot” information; e.g. an information at which slot of a superframe a frame comprising the synchronization information begins] defining [and/or describing] a timing of the transmission of the synchronization information [e.g. a timing of a preamble of a packet comprising the synchronization information] with respect to [e.g. relative to] the reference time [e.g. with respect to a first slot of a current superframe].

### Aspects Regarding the First Apparatuses 16′ and 16″

In examples above, there is disclosed a first communication apparatus 16′ or 16″ [e.g. user equipment UE, mobile device, etc.] [e.g. for a wireless communication, e.g. optical communication or RF communication] configured to receive [e.g. in downlink and/or in uplink] a synchronization information [e.g. having a variable timing with respect to the reference time] [e.g. for different superframes the synchronization information may be transmitted in different timings (e.g. delays) relative to the reference time];
wherein the first communication apparatus (16′, 16″) is configured to transmit and/or receive [e.g. in a superframe] a plurality of packets using a scheduling [e.g. defined by an (individual) assignment of slots (or slices, which may comprise a plurality of slots) in a superframe to different communication devices (e.g. designated as “GTS”) and/or defined by an assignment of slots (or slices) to a random transmission (e.g. designated with “RTS”)] related to a reference time [e.g. a beginning of a superframe; e.g. a first slot of a superframe, the reference may be periodical, but in alternative it can change; notwithstanding the reference time can be updated for a new superframe] [e.g. the transmissions and/or reception being synchronized to the reference time];
wherein the first communication apparatus (16′, 16″) is configured to evaluate a timing information [e.g. a “sync slot” information; e.g. an information at which slot of a superframe a frame comprising the synchronization information begins], which is included [e.g. encoded] in a synchronization information and which defines [and/or describes] a timing of the transmission of the synchronization information [e.g. a timing of a preamble of a packet comprising the synchronization information] with respect to [e.g. relative to] the reference time [e.g. with respect to a first slot of a current superframe], in order to perform a synchronization [e.g. in order to synchronize its clock to the received synchronization information, e.g. by reducing an offset between its (local) clock and a time indicate by the timing information within the synchronization information]] [e.g., the communication device may therefore obtain the knowledge of which time instant was the reference time, to thereby subsequently transmit and/or receive the next frames using the updated timing related to the reference time].

The first communication apparatus 16′ or 16″ may be configured to evaluate, from the timing information, a time distance [e.g. in time slots] from the transmission of the synchronization information [e.g. the timing of a preamble of the packet comprising the synchronization information] and the timing reference [e.g. by subtracting the time distance from the transmission of the synchronization information, to thereby obtain the knowledge of which time instant was the reference time, to thereby subsequently transmit and/or receive the next frames using the updated timing related to the reference time].

The first communication apparatus 16′ or 16″ may be configured to evaluate, from the timing information, information on the time distance from the timing reference to the next timing reference [e.g. “total superframe slots”].

The first communication apparatus (e.g. 16′) may be configured to receive scheduling information assigning exclusive time slots to it, while different exclusive time slots are assigned to different first communication apparatuses (e.g. 16″), so that the first communication apparatus 16′ transmits in the time slots assigned to it and refrains from transmitting in the time slots assigned to the different first communication apparatuses 16″ [and/or some unused time slots, which may be for example used by the master, for example, e.g. in case of urgency].

The first communication apparatus 16′ or 16″ may be configured to receive scheduling information assigning exclusive time slots [e.g., one slice, which comprises a plurality of slots, e.g. a plurality of consecutive slots] to the second communication apparatus (e.g. master communication apparatus) 15 [or communication arrangement, base station, or coordinator, or scheduler] for the transmission [e.g. in downlink] of at least part of control signalization, so that the first communication apparatus receives the control signalization in the time slots assigned to the transmission [e.g. in downlink] of the at least control signalization [control signalization may include scheduling information, synchronization information (including the timing information)] [the scheduling information may include the GTS descriptor element and/or RTS descriptor elements] [multiple control signalizations may be transmitted in at least one packet; they may be distinguished through various techniques, e.g. by using different preambles, or anyway different unique sequences, for each control signalization] [e.g. in some examples, the transmission of a control signalization may delayed, e.g. in view of the necessity of a transmission or reception of a payload data, e.g. like the control signalization 81b being shifted from t₀ to t₁ in FIG. 2; this may occur, for example, in case of necessity of addressing a requirement set out by a higher-layer application].

The first communication apparatus 16′ or 16″ may be configured to receive at least some control signalization event-driven (e.g., in a different channel and/or in different time slots granted only for the only to be used for receiving at least some control signalization, and/or in at least one RTS; in some examples, the first communication apparatus may be remaining waiting for receiving transmissions from the master communication apparatus 15 (or communication arrangement, base station, or coordinator, or scheduler or second communication apparatus) during the non-assigned time slots, and the master communication apparatus 15 (or communication arrangement, base station, or coordinator, or scheduler or second communication apparatus) may therefore occupy the non-assigned slots to transmit at least some control signalization event-driven, without necessarily scheduling those event-driven control signalization(s)) [in the example of FIG. 2, it may be that the control signalization 81b is delayed (shifted towards later time), but in some examples this does not necessarily requires a scheduling to be defined and provided to the other different communication apparatuses, because the new time slots which are now occupied by the control signalization 81b were not assigned to any of the other communication devices 15, 16′, 16″, etc.] [control signalization may include scheduling information, synchronization information (including the timing information)] [the scheduling information may include the GTS descriptor element and/or RTS descriptor elements] [multiple control signalizations may be transmitted in at least one packet; they may be distinguished through various techniques, e.g. by using different preambles, or anyway different unique sequences, for each control signalization]] [e.g. in some examples, the transmission of a control signalization may delayed, e.g. in view of the necessity of a transmission or reception of a payload data, e.g. like the control signalization 81b being shifted from t₀ to t₁ in FIG. 2; this may occur, for example, in case of necessity of addressing a requirement set out by a higher-layer application].

The first communication apparatus 16′ or 16″ may be such that the control signalization includes [e.g. has encoded therein] scheduling information for the subsequent transmissions.

The first communication apparatus 16′ or 16″, wherein the control signalization includes [e.g. has encoded therein] the synchronization information for the subsequent transmissions.

The first communication apparatus 16′ or 16″ may be such that the control signalization includes [e.g. has encoded therein] announcement information [e.g. in which there is encoded information human-readable information, such as encoded in UTF-8 string, ASCII code, etc.]

The second communication apparatus 16′ or 16″ may be such that the control signalization includes [e.g. has encoded therein] random access timing information [e.g. being or including a RTS descriptor element], providing information on slots [e.g. in respect to the timing reference, or reference time] which are grant-free.

The first communication apparatus 16′ or 16″, wherein the control signalization includes [e.g. has encoded therein] granted access timing information [e.g. being or including a GTS descriptor element], providing information on time slots [e.g. in respect to the reference time] which are grant-free.

The first communication apparatus 16′ or 16″ may be such that if information on characteristics of real-time application data streams as defined by a higher-layers application requires a particular maximum latency for the transmission and/or reception of a particular transmission, time slots, which are not scheduled for the first communication apparatus, are awarded to the different communication apparatus (e.g. by quickly rescheduling on-the-fly) [other transmissions from the master communication apparatus 15 (e.g. control signalizations) may be shifted towards subsequent time slots] [this may occur, for example, in case the higher-layer application specifies some payload transmissions as having a high ranking urgency].

In examples disclosed above, the communication method [e.g. at a user equipment UE, mobile device, etc.] [e.g. for a wireless communication, e.g. optical communication or RF communication] comprising
receiving a synchronization information [e.g. having a variable timing with respect to the reference time] [e.g. for different superframes the synchronization information may be transmitted in different timings (e.g. delays) relative to the reference time];
transmitting and/or receiving [e.g. in a superframe] a plurality of packets using a scheduling [e.g. defined by an (individual) assignment of slots (or slices, which may comprise a plurality of slots) in a superframe to different communication devices (e.g. designated as “GTS”) and/or defined by an assignment of slots (or slices) to a random transmission (e.g. designated with “RTS”)] related to a reference time [e.g. a beginning of a superframe; e.g. a first slot of a superframe, the reference may be periodical, but in alternative it can change; notwithstanding the reference time can be updated for a new superframe] [e.g. the transmissions and/or reception being synchronized to the reference time];
evaluating a timing information [e.g. a “sync slot” information; e.g. an information at which slot of a superframe a frame comprising the synchronization information begins], which is included [e.g. encoded] in a synchronization information and which defines [and/or describes] a timing of the transmission of the synchronization information [e.g. a timing of a preamble of a packet comprising the synchronization information] with respect to [e.g. relative to] the reference time [e.g. with respect to a first slot of a current superframe], in order to perform a synchronization [e.g. in order to synchronize its clock to the received synchronization information, e.g. by reducing an offset between its (local) clock and a time indicate by the timing information within the synchronization information]] [e.g., the communication device may therefore obtain the knowledge of which time instant was the reference time, to thereby subsequently transmit and/or receive the next frames using the updated timing related to the reference time].

There is also described a non-transitory storage unit storing instructions which, when executed by a processor, cause the processor to
control the reception of a synchronization information [e.g. having a variable timing with respect to the reference time] [e.g. for different superframes the synchronization information may be transmitted in different timings (e.g. delays) relative to the reference time];
control the transmission and/or reception [e.g. in a superframe] of a plurality of packets using a scheduling [e.g. defined by an (individual) assignment of slots (or slices, which may comprise a plurality of slots) in a superframe to different communication devices (e.g. designated as “GTS”) and/or defined by an assignment of slots (or slices) to a random transmission (e.g. designated with “RTS”)] related to a reference time [e.g. a beginning of a superframe; e.g. a first slot of a superframe, the reference may be periodical, but in alternative it can change; notwithstanding the reference time can be updated for a new superframe] [e.g. the transmissions and/or reception being synchronized to the reference time];
evaluate a timing information [e.g. a “sync slot” information; e.g. an information at which slot of a superframe a frame comprising the synchronization information begins], which is included [e.g. encoded] in a synchronization information and which defines [and/or describes] a timing of the transmission of the synchronization information [e.g. a timing of a preamble of a packet comprising the synchronization information] with respect to [e.g. relative to] the reference time [e.g. with respect to a first slot of a current superframe], in order to perform a synchronization [e.g. in order to synchronize its clock to the received synchronization information, e.g. by reducing an offset between its (local) clock and a time indicate by the timing information within the synchronization information]] [e.g., the communication device may therefore obtain the knowledge of which time instant was the reference time, to thereby subsequently transmit and/or receive the next frames using the updated timing related to the reference time].

Also, further examples will be defined by the enclosed claims (examples are also in the claims). It should be noted that any example as defined by the claims can be supplemented by any of the details (features and functionalities) described in the following chapters.

Also, the examples described in the following chapters can be used individually, and can also be supplemented by any of the features in another chapter, or by any feature included in the claims.

Also, it should be noted that individual aspects described herein can be used individually or in combination. Thus, details can be added to each of said individual aspects without adding details to another one of said aspects.

It should also be noted that the present disclosure describes, explicitly or implicitly, features of a mobile communication device and of a receiver and of a mobile communication system. Thus, any of the features described herein can be used in the context of a mobile communication device and in the context of a mobile communication system (e.g. comprising a satellite, a mobile communication network, etc.).

Moreover, features and functionalities disclosed herein relating to a method can also be used in an apparatus. Furthermore, any features and functionalities disclosed herein with respect to an apparatus can also be used in a corresponding method. In other words, the methods disclosed herein can be supplemented by any of the features and functionalities described with respect to the apparatuses.

Also, any of the features and functionalities described herein can be implemented in hardware or in software, or using a combination of hardware and software, as described a.

Depending on certain implementation requirements, examples may be implemented in hardware. The implementation may be performed using a digital storage medium, for example a floppy disk, a Digital Versatile Disc (DVD), a Blu-Ray Disc, a Compact Disc (CD), a Read-only Memory (ROM), a Programmable Read-only Memory (PROM), an Erasable and Programmable Read-only Memory (EPROM), an Electrically Erasable Programmable Read-Only Memory (EEPROM) or a flash memory, having electronically readable control signals stored thereon, which cooperate (or are capable of cooperating) with a programmable computer system such that the respective method is performed. Therefore, the digital storage medium may be computer readable.

Generally, examples may be implemented as a computer program product with program instructions, the program instructions being operative for performing one of the methods when the computer program product runs on a computer. The program instructions may for example be stored on a machine readable medium.

Other examples comprise the computer program for performing one of the methods described herein, stored on a machine readable carrier. In other words, an example of method is, therefore, a computer program having a program instructions for performing one of the methods described herein, when the computer program runs on a computer.

A further example of the methods is, therefore, a data carrier medium (or a digital storage medium, or a computer-readable medium) comprising, recorded thereon, the computer program for performing one of the methods described herein. The data carrier medium, the digital storage medium or the recorded medium are tangible and/or non-transitionary, rather than signals which are intangible and transitory.

A further example comprises a processing unit, for example a computer, or a programmable logic device performing one of the methods described herein.

A further example comprises a computer having installed thereon the computer program for performing one of the methods described herein.

A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some examples, a programmable logic device (for example, a field programmable gate array) may be used to perform some or all of the functionalities of the methods described herein. In some examples, a field programmable gate array may cooperate with a microprocessor in order to perform one of the methods described herein. Generally, the methods may be performed by any appropriate hardware apparatus.

The above described examples are illustrative for the principles discussed above. It is understood that modifications and variations of the arrangements and the details described herein will be apparent. It is the intent, therefore, to be limited by the scope of the impending patent claims and not by the specific details presented by way of description and explanation of the examples herein.

The claims add embodiments and/or alternatives to the invention (e.g., in square brackets or in round brackets and/or in alternative or in examples).

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A communication apparatus,
wherein the communication apparatus is configured to transmit and/or receive a plurality of packets using a scheduling related to a reference time;
wherein the communication apparatus is configured to transmit a synchronization information;
wherein the communication apparatus is configured to include into the synchronization information a timing information defining a timing of the transmission of the synchronization information with respect to the reference time.

2. The communication apparatus of claim 1, configured to include, in the timing information, a time distance from the transmission of the synchronization information and the reference time.

3. The communication apparatus of claim 1, configured to include, in the timing information, information on the time distance from the reference time to the next timing reference.

4. The communication apparatus of claim 1, configured to provide scheduling information to the different communication apparatuses assigning exclusive time slots to each of the different communication apparatuses.

5. The communication apparatus of claim 1, configured to provide, to the different communication apparatuses, scheduling information assigning exclusive time slots to the communication apparatus for the transmission of at least some control signalization.

6. The communication apparatus of claim 1, configured to further transmit at least some control signalization event-driven.

7. The communication apparatus of claim 5, wherein the control signalization includes at least the synchronization information.

8. The communication apparatus of claim 5, configured to delay or to anticipate the transmission of a control signalization in case a higher-layer application requires the transmission and/or reception of a transmission.

9. The communication apparatus of claim 5, configured, in case of the higher-layer application requiring the transmission and/or reception of a transmission of a payload data, to check whether, according to the scheduling, at least some slots are free, and to therefore delay or anticipate the transmission of the control signalization in the free slots in a same superframe, otherwise waiting for the next superframe.

10. The communication apparatus of claim 5, wherein the control signalization includes scheduling information for the subsequent transmissions.

11. The communication apparatus of claim 5, wherein the control signalization includes the synchronization information for the subsequent transmissions.

12. The communication apparatus of claim 5, wherein the control signalization includes announcement information.

13. The communication apparatus of claim 5, wherein the control signalization includes random access timing information providing information on slots which are grant-free.

14. The communication apparatus of claim 5, wherein the control signalization includes granted access timing information providing information on time slots which are grant-free.

15. The communication apparatus of claim 5, configured to define the scheduling information by keeping into account traffic.

16. The communication apparatus of claim 15, to define the scheduling information by:
in case of comparatively higher traffic congestion, reducing the amount of time slots for the transmission of control signalization and/or increasing the amount of granted time slots assigned to at least one of the different communication apparatuses; and/or
in case of comparatively lower traffic congestion, increasing the amount of time slots for the transmission of control signalization and/or reducing the amount of granted time slots assigned to at least one of the different communication apparatuses.

17. The communication apparatus of claim 15, wherein the urgency of the transmissions and/or receptions is ranked according to an urgency ranking, wherein the communication apparatus is configured to
in case of comparatively higher ranking transmissions and/or receptions, reducing the amount of time slots for the transmission of control signalization and/or increasing the amount of granted time slots assigned to at least one of the different communication apparatuses; and/or
in case of comparatively lower ranking transmissions and/or receptions, increasing the amount of time slots for the transmission of control signalization and/or reducing the amount of granted time slots assigned to at least one of the different communication apparatuses.

18. The communication apparatus of claim 15, configured to define the scheduling by reinstating the time slots for the transmission of the control signalization in case of a threshold condition is reached.

19. The communication apparatus of claim 1, further comprising a plurality of frontends configured to simultaneously transmit and/or receive different packets through the different frontends.

20. The communication apparatus of claim 19, configured to selectively simultaneously transmit synchronization information in different time slots for different frontends.

21. The communication apparatus of claim 1, including or being connected to a higher-layer application, the communication apparatus using information on characteristics of real-time application data streams from the higher-layer application.

22. The communication apparatus of claim 21, wherein the information on characteristics of real-time application data streams contain one or more of the following: the periodicity of application data streams, the maximum allowed delay, the maximum allowed delay variation, the maximum allowed loss ratio of datagrams.

23. The communication apparatus of claim 21, wherein the communication apparatus is configured to use the information on the characteristics of real-time application data streams, e.g. in such a way that, if the information on the characteristics of real-time application data streams requires a particular maximum latency for the transmission and/or reception of a particular transmission, time slots, which are not scheduled for a particular different communication apparatus, are awarded to the different communication apparatus, and/or other transmissions from the communication apparatus are shifted towards subsequent time slots.

24. The communication apparatus of claim 1, configured to transmit and/or receive the plurality of packets as wireless signals and to transmit the synchronization information in a wireless signal.

25. The communication apparatus of claim 1, configured to transmit and/or receive the plurality of packets as optical signals and to transmit the synchronization information in optical signal.

26. A communication method, comprising:
transmitting and/or receiving a plurality of packets using a scheduling related to a reference time;
the method further comprising transmitting a synchronization information;
wherein transmitting a synchronization information comprises including into the synchronization information a timing information defining a timing of the transmission of the synchronization information with respect to the reference time.

27. A non-transitory storage unit storing instructions which, when executed by a processor, cause the processor to:
control the transmission and/or reception of a plurality of packets using a scheduling related to a reference time;
control the transmission of a synchronization information;
wherein the synchronization information comprises including into the synchronization information a timing information defining a timing of the transmission of the synchronization information with respect to the reference time.

28. A communication apparatus,
wherein the communication apparatus is configured to receive a synchronization information;
wherein the communication apparatus is configured to transmit and/or receive a plurality of packets using a scheduling related to a reference time;
wherein the communication apparatus is configured to evaluate a timing information, which is included in a synchronization information and which defines a timing of the transmission of the synchronization information with respect to the reference time, in order to perform a synchronization.

29. The communication apparatus of claim 28, configured to evaluate, from the timing information, information on the time distance from the timing reference to the next timing reference.

30. The communication apparatus of claim 28, configured to resynchronize by comparing the time position of the reference time as measured with the timing information.

31. The communication apparatus of claim 29, configured to read the timing information so as to acknowledge a time drift with respect to the timing information, and to thereby modify the time knowledge with the time drift.

32. The communication apparatus of claim 29, configured to count a number of slots between the current reference time and the start the synchronization information, and compare the counted number of slots with a number encoded in the timing information, to thereby calculate an offset and compensate for the offset by adjusting its timing to the timing information.

33. The communication apparatus of claim 28, configured to receive scheduling information assigning exclusive time slots to the communication apparatus and different exclusive time slots to different communication apparatuses, so that the communication apparatus transmits in the time slots assigned to it and refrains from transmitting in the time slots assigned to the different communication apparatuses.

34. The communication apparatus of claim 28, configured to receive scheduling information assigning exclusive time slots to a master communication apparatus for the transmission of control signalization, so that the communication apparatus receives the control signalization in the time slots assigned to the transmission of the at least control signalization.

35. The communication apparatus of claim 28, configured to receive at least some control signalization event-driven during the non-assigned time slots, and the master communication apparatus may therefore occupy the non-assigned slots to transmit at least some control signalization event-driven, without necessarily scheduling those event-driven control signalization(s)).

36. The communication apparatus of claim 34, wherein the control signalization includes scheduling information for the subsequent transmissions.

37. The communication apparatus of claim 34, wherein the control signalization includes the synchronization information for the subsequent transmissions.

38. The communication apparatus of claim 34, wherein the control signalization includes announcement information.

39. The communication apparatus of claim 34, wherein the control signalization includes random access timing information, providing information on slots which are grant-free.

40. The communication apparatus of claim 34, wherein the control signalization includes granted access timing information, providing information on time slots which are grant-free.

41. The communication apparatus of claim 34, configured to include, or be connected to, a high-layer application, wherein the communication apparatus is configured to receive payload data from the higher-layer application and transmit the payload data according to the scheduling, and/or wherein the communication apparatus is configured to transmit payload data to the higher-layer application received according to the scheduling.

42. The communication apparatus of claim 28, wherein, if information on characteristics of real-time application data streams as defined by a higher-layers application requires a particular maximum latency for the transmission and/or reception of a particular transmission, time slots, which are not scheduled for the communication apparatus, are awarded to the different communication apparatus.

43. The communication apparatus of claim 28, configured to evaluate, from the timing information, a time distance between the timing information as encoded and the timing reference as measured.

44. The communication apparatus of claim 28, configured, in case of drift between the timing information as encoded and the timing reference as measured, to adjust the internal clock to the timing information as encoded.

45. The communication apparatus of claim 28, configured to transmit and/or receive the plurality of packets as wireless signals and to receive the synchronization information in wireless signals.

46. The communication apparatus of claim 28, configured to transmit and/or receive the plurality of packets as optical signals and to receive the synchronization information in optical signals.

47. A communication method comprising
receiving a synchronization information;
transmitting and/or receiving a plurality of packets using a scheduling related to a reference time;
evaluating a timing information, which is included in a synchronization information and which defines a timing of the transmission of the synchronization information with respect to the reference time, in order to perform a synchronization.

48. A non-transitory storage unit storing instructions which, when executed by a processor, cause the processor to
control the reception of a synchronization information;
control the transmission and/or reception of a plurality of packets using a scheduling related to a reference time;
evaluate a timing information, which is included in a synchronization information and which defines a timing of the transmission of the synchronization information with respect to the reference time, in order to perform a synchronization.
